(19) United States
(12) Patent Application Publication
(10) Pub. No.: US 2013/0074587 A1
(43) Pub. Date: Mar. 28, 2013

(54) SYSTEM AND METHOD FOR DISSOLUTION ANALYSIS OF DRUG-ELUTING MEDICAL DEVICES

(71) Applicant: Mel Merciadez, Avenel, NJ (US)

(72) Inventor: Mel Merciadez, Avenel, NJ (US)

(21) Appl. No.: 13/246,898

(22) Filed: Sep. 28, 2011

(51) Int. Cl. G01N 37/00

(52) U.S. Cl. 73/64.56

(57) ABSTRACT

This disclosure is directed to systems and methods for holding a medical device such as a stent undergoing dissolution analysis. A clip retains the device in a specific, reproducible orientation and positions it within a sample cell of the dissolution testing apparatus. Preferably, the medical device is positioned away from areas having relatively greater flow turbulence.

### FIELD OF THE PRESENT INVENTION

The present disclosure generally relates the determination of pharmacokinetic characteristics of medical devices and more particularly to dissolution studies of a drug-eluting stent.

### BACKGROUND OF THE INVENTION

The use of a medical device to control the delivery of a pharmacological or therapeutic agent over time has a wide variety of applications. For example, renarrowing (restenosis) of an artherosclerotic coronary artery after percutaneous transluminal coronary angioplasty (PTCA) occurs in 10-50% of patients undergoing this procedure and subsequently requires either further angioplasty or coronary artery bypass graft. Smooth muscle cells (SMCs) in the vessel wall appear to react to the procedure, an event viewed as a primary factor causing restenosis. Correspondingly, a number of attempts have been made to inhibit aspects of SMC activity using pharmacological agents. One promising strategy involves the use of stents which have been treated or modified to carry and deliver the agent directly to the vessel wall.

As will be appreciated, the use of a stent or other medical device to deliver a pharmacological agent over a period of time requires an accurate characterization of the kinetic release profile of the agent. The United States Pharmacopeia (USP) has developed a standard for analyzing the dissolution rates of pharmacological agents. Using USP Apparatus 4, a dissolution solvent is pumped through a sample cell containing the material to be studied. Although conventionally used for drug formulations designed for release over time, such as tablets, capsules or pills, the USP Apparatus 4 is also used to study the release of drugs from suitable medical devices, such as drug-eluting stents.

Within a sample cell, flow conditions often vary significantly. Current sample cells are not configured to hold the medical device being tested in a uniform location or orientation within the cell. Accordingly, the lack of reproducibility in the positioning of the medical device can significantly hinder release kinetic studies. Thus, it would be advantageous to provide a system and method for reliably positioning a device undergoing dissolution analysis and maintaining that positioning during testing. Similarly, it would be advantageous to position a medical device undergoing testing away from areas known to have highly variable flow conditions. This invention accomplishes these and other goals.

### SUMMARY OF THE INVENTION

In accordance with the above needs and those that will be mentioned and will become apparent below, this disclosure is directed to a holder for a medical device undergoing dissolution analysis comprising a clip having first and second adjacent elongated members, each with proximal and distal ends, and a bridge joining the distal ends of the first and second elongated members, wherein the elongated members can be placed in an open configuration to receive a medical device and a closed configuration to retain the medical device. Preferably, the clip is configured to retain a stent. Also preferably, the elongated members and bridge are formed from stainless steel. As desired, clip can also include a handle secured to the proximal end of the first elongated member.

Another aspect of the disclosure is directed to a system for holding a medical device undergoing dissolution analysis comprising a clip having first and second adjacent elongated members, each with proximal and distal ends, and a bridge joining the distal ends of the first and second elongated members, and a sample cell having an inlet and an outlet. The system preferably includes a medical device, such as a stent, retained in a specific orientation by the elongated members of the clip. Preferably, the medical device is retained at a position away from the inlet of the sample cell. Also preferably, the clip is configured to be held at a specific position within the sample cell.

In yet another aspect, this disclosure is directed to a method for holding a medical device undergoing dissolution analysis comprising the steps of providing a clip having first and second adjacent elongated members, each with proximal and distal ends, and a bridge joining the distal ends of the first and second elongated members, positioning a medical device at a reproducible orientation within the clip when the clip is in an open configuration, retaining the medical device in the reproducible orientation by placing the clip in a closed configuration with the elongated members engaging the medical device, and positioning the clip within a sample cell. Preferably, the step of positioning a medical device includes positioning a stent. Also preferably, the step of positioning the clip within a sample cell includes positioning the medical device away from an inlet of the sample cell or constraining the clip to a specific location.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is an isometric view of a stent suitable for use with the invention;

FIG. 2 is a schematic illustration of a portion of a dissolution testing apparatus, according to the invention;

FIG. 3 is an isometric view of a clip for holding a medical device during dissolution testing in an open configuration, according to the invention; and

FIG. 4 is an isometric view of the clip shown in FIG. 3 in a closed configuration, according to the invention.

### DETAILED DESCRIPTION OF THE INVENTION

At the outset, it is to be understood that this disclosure is not limited to particularly exemplified materials, architectures, routines, methods or structures as such may, of course, vary. Thus, although a number of such option, similar or equivalent to those described herein, can be used in the practice of embodiments of this disclosure, the preferred materials and methods are described herein.

It is also to be understood that the terminology used herein is for the purpose of describing particular embodiments of this disclosure only and is not intended to be limiting.

Unless defined otherwise, all technical and scientific terms used herein have the same meaning as commonly understood by one having ordinary skill in the art to which the disclosure pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

As referenced above, medical devices such as stents can be configured to achieve controlled release of therapeutic agents over time. Local delivery of drug or drug combinations from a stent has the significant advantages; namely, the prevention of vessel recoil and remodeling through the scaffolding action of the stent and the prevention of multiple components of neointimal hyperplasia or restenosis as well as a reduction in inflammation and thrombosis. This local administration of drugs, agents or compounds to stented coronary arteries may also have additional therapeutic benefit. For example, higher tissue concentrations of the drugs, agents or compounds may be achieved utilizing local delivery, rather than systemic administration. In addition, reduced systemic toxicity may be achieved utilizing local delivery rather than systemic administration while maintaining higher tissue concentrations. Also in utilizing local delivery from a stent rather than systemic administration, a single procedure may suffice with better patient compliance. An additional benefit of combination drug, agent, and/or compound therapy may be to reduce the dose of each of the therapeutic drugs, agents or compounds, thereby limiting their toxicity, while still achieving a reduction in restenosis, inflammation and thrombosis. Local stent based therapy is therefore a means of improving the therapeutic ratio (efficacy/toxicity) of anti-restenosis, anti-inflammatory, anti-thrombotic drugs, agents or compounds.

There are a multiplicity of different stents that may be utilized following PTCA. Although any number of stents may be utilized in accordance with the present invention, for simplicity, a single stent is described in exemplary embodiments of the present invention. The skilled artisan will recognize that any number of stents may be utilized in connection with the present invention. In addition, as stated above, other medical devices may be utilized.

A stent is commonly used as a tubular structure left inside the lumen of a duct to relieve an obstruction. Commonly, stents are inserted into the lumen in a non-expanded form and are then expanded autonomously, or with the aid of a second device in situ. A typical method of expansion occurs through the use of a catheter-mounted angioplasty balloon which is inflated within the stenosed vessel or body passageway in order to shear and disrupt the obstructions associated with the wall components of the vessel and to obtain an enlarged lumen.

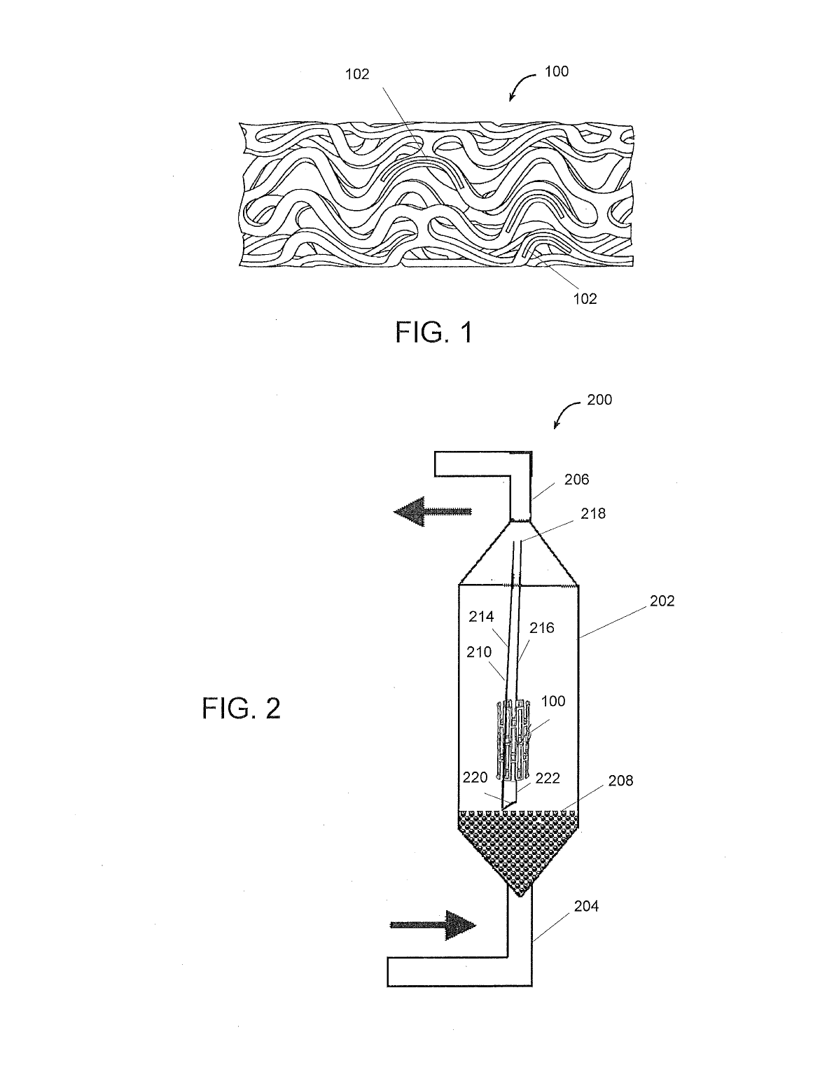

FIG. 1 illustrates an exemplary drug-eluting stent 100 which may be utilized in accordance with an exemplary embodiment of the present invention. The expandable cylindrical stent 100 comprises a fenestrated structure for placement in a blood vessel, duct or lumen to hold the vessel, duct or lumen open, more particularly for protecting a segment of artery from restenosis after angioplasty. The stent 100 may be expanded circumferentially and maintained in an expanded configuration, which is circumferentially or radially rigid. The stent 100 is axially flexible and when flexed at a band, the stent 100 avoids any externally protruding component parts.

The stent 100 may be fabricated utilizing any number of methods. For example, the stent 100 may be fabricated from a hollow or formed stainless steel tube that may be machined using lasers, electric discharge milling, chemical etching or other means. The stent 100 is inserted into the body and placed at the desired site in an unexpanded form. In one exemplary embodiment, expansion may be effected in a blood vessel by a balloon catheter, where the final diameter of the stent 100 is a function of the diameter of the balloon catheter used.

It should be appreciated that a stent 100 in accordance with the present invention may be embodied in a shape-memory material, including, for example, an appropriate alloy of nickel and titanium or stainless steel. Structures formed from stainless steel may be made self-expanding by configuring the stainless steel in a predetermined manner, for example, by twisting it into a braided configuration. In this embodiment after the stent 100 has been formed it may be compressed so as to occupy a space sufficiently small as to permit its insertion in a blood vessel or other tissue by insertion means, wherein the insertion means include a suitable catheter, or flexible rod. On emerging from the catheter, the stent 100 may be configured to expand into the desired configuration where the expansion is automatic or triggered by a change in pressure, temperature or electrical stimulation.

Further, the stent 100 may feature one or more reservoirs 102. Each of the reservoirs 102 may be opened or closed as desired. These reservoirs 102 may be specifically designed to hold the agent(s) to be delivered. Regardless of the design of the stent 100, it is preferable to have the dosage applied with enough specificity and a sufficient concentration to provide an effective dosage in the lesion area. In this regard, the size, shape, position, and number of reservoirs can be used to control the amount of agent released, and therefore the dose delivered. Further, a coating or membrane of biocompatable material can be applied over the reservoirs as desired to provide additional control over the diffusion of the agent from the reservoirs to the artery wall. One advantage of this system is that the properties of the coating can be optimized for achieving superior biocompatibility and adhesion properties, without the addition requirement of being able to load and release the drug. In alternate exemplary embodiments, all or a portion of the inner and outer surface of the stent 100 may be coated, covered with a membrane containing or bombarded with agent(s) in therapeutic dosage amounts.

Presently preferred therapeutic and pharmaceutical agents that may be used singly or in combination include: anti-proliferative/antimitotic agents including natural products such as vinca alkaloids (i.e. vinblastine, vincristine, and vinorelbine), paclitaxel, epidipodophyllotoxins (i.e. etoposide, teniposide), antibiotics (dactinomycin (actinomycin D) daunorubicin, doxorubicin and idarubicin), anthracyclines, mitoxantrone, bleomycins, plicamycin (mithramycin) and mitomycin, enzymes (L-asparaginase which systemically metabolizes L-asparagine and deprives cells which do not have the capacity to synthesize their own asparagine); antiplatelet agents such as G(GP) llbl llla inhibitors and vitronectin receptor antagonists; anti-proliferative/antimitotic alkylating agents such as nitrogen mustards (mechlorethamine, cyclophosphamide and analogs, melphalan, chlorambucil), ethylenimines and methylmelamines (hexamethylmelamine and thiotepa), alkyl sulfonates-busulfan, nirtosoureas (carmustine (BCNU) and analogs, streptozocin), trazenes-dacarbazinine (DTIC); antiproliferative/antimitotic antimetabolites such as folic acid analogs (methotrexate), pyrimidine analogs (fluorouracil, floxuridine, and cytarabine), purine analogs and related inhibitors (mercaptopurine, thioguanine, pentostatin and 2-chlorodeoxyadenosine {cladribine}); platinum coordination complexes (cisplatin, carboplatin), procarbazine, hydroxyurea, mitotane, aminoglutethimide; hormones (i.e. estrogen); anti-coagulants (heparin, synthetic heparin salts and other inhibitors of thrombin); fibrinolytic agents (such as tissue plasminogen activator, streptokinase and urokinase), aspirin, dipyridamole, ticlopidine, clopidogrel, abciximab; antimigratory; antisecretory (breveldin); anti-inflammatory: such as adrenocortical steroids (Cortisol, cortisone, fludrocortisone, prednisone, prednisolone, 6a-methylprednisolone, triamcinolone, betamethasone, and dexamethasone), nonsteroidal agents (salicylic acid derivatives i.e. aspirin; paraminophenol derivatives i.e. acetaminophen; indole and indene acetic acids (indomethacin, sulindac, and etodalac), heteroaryl acetic acids (tolmetin, diclofenac, and ketorolac), arylpropionic acids (ibuprofen and derivatives), anthranilic acids (mefenamic acid, and meclofenamic acid), enolic acids (piroxicam, tenoxicam, phenylbutazone, and oxyphenthatrazone), nabumetone, gold compounds (auranofin, aurothioglucose, gold sodium thiomalate); immunosuppressives: (cyclosporin, tacrolimus (FK-506), sirolimus (rapamycin), azathioprine, mycophenolate mofetil); angiogenic agents: vascular endothelial growth factor (VEGF), fibroblast growth factor (FGF); angiotensin receptor blockers; nitric oxide donors; antisense oligionucleotides and combinations thereof; cell cycle inhibitors, mTOR inhibitors, and growth factor receptor signal transduction kinase inhibitors; retenoids; cyclin/CDK inhibitors; HMG co-enzyme reductase inhibitors (statins); and protease inhibitors.

While exemplary embodiments of the invention will be described with respect to the treatment of restenosis and related complications using stents following PTCA, it is important to note that the local delivery of agent(s) may be utilized to treat a wide variety of conditions utilizing any number of medical devices, or to enhance the function and/or life of the device. For example, intraocular lenses, placed to restore vision after cataract surgery is often compromised by the formation of a secondary cataract. The latter is often a result of cellular overgrowth on the lens surface and can be potentially minimized by combining a drug or drugs with the device. Other medical devices which often fail due to tissue in-growth or accumulation of proteinaceous material in, on and around the device, such as shunts for hydrocephalus, dialysis grafts, colostomy bag attachment devices, ear drainage tubes, leads for pace makers and implantable defibrillators can also benefit from the device-drug combination approach. Devices which serve to improve the structure and function of tissue or organ may also show benefits when combined with the appropriate agent or agents. For example, improved osteointegration of orthopedic devices to enhance stabilization of the implanted device could potentially be achieved by combining it with agents such as bone-morphogenic protein. Similarly other surgical devices, sutures, staples, anastomosis devices, vertebral disks, bone pins, suture anchors, hemostatic barriers, clamps, screws, plates, clips, vascular implants, tissue adhesives and sealants, tissue scaffolds, various types of dressings, bone substitutes, intraluminal devices, and vascular supports could also provide enhanced patient benefit using this drug-device combination approach. Perivascular wraps may be particularly advantageous, alone or in combination with other medical devices. The perivascular wraps may supply additional drugs to a treatment site. Essentially, any type of medical device may be coated in some fashion with a drug or drug combination which enhances treatment over use of the singular use of the device or pharmaceutical agent.

One of skill in the art will recognize that the dissolution characteristics of a pharmacological agent depend upon its chemical properties and its particular formulation. As such, these characteristics must be well understood to predict the effects of a drug as well as ensuring consistency of product during manufacture. A currently preferred standard for analyzing dissolution for controlled release drug formulations are USP Apparatus 4 flow through systems. Accordingly, significant flexibility is associated with these systems, including the ability to operate under different conditions, such as open or closed configurations, and with different flow rates and temperatures. A wide range of sample cells having holders configured for various dosage forms, including controlled release oral powders, granules, and solid dispersions. A Type 4 Apparatus can also allow variation of media volume, allowing decreased volumes to improve the detection limit or increased volumes for maintaining sink conditions.

FIG. 2 schematically illustrates a portion of the components of a USP Apparatus 4. A flow-through sample cell 200 includes chamber 202 configured to direct the flow of the dissolution solvent. As such, solvent is pumped through cell 200, entering at inlet 204 and exiting through outlet 206. In closed configurations, a fixed amount of solvent is recirculated and the dissolution of the drug will be associated with an increasing concentration in the solvent. Alternatively, in open configurations, fresh solvent is continually pumped through inlet 204 and the solvent exiting outlet 206 is analyzed to determine the amount of dissolved drug.

Given that the solvent is being pumped through sample cell 202, it will be recognized that the fluid dynamics vary within cell 202. In particular, areas adjacent inlet 204 will experience relatively higher degrees of turbulence as compared to areas adjacent outlet 206, for example. In some embodiments, a plurality of glass beads 208 are deposited at the inlet 204 to minimize turbulence and produce a more laminar flow.

As discussed above, conventional sample cells have no specific mechanism or configuration for reproducibly positioning a medical device within the sample cell at a given location and orientation. Thus, medical devices undergoing dissolution analysis using conventional sample cells have the potential of experiencing different flow characteristics depending upon their location and orientation. Correspondingly, identical medical devices having the same drug formulation can still exhibit differing dissolution characteristics, diminishing the precision of the dissolution analysis.

To minimize these effects, the systems and methods of this invention employ a clip 210 to position a medical device, such as stent 100, at a reproducible location and orientation within cell 202. Clip 210 features two adjacent aligned elongated members 214 and 216, which are unattached at proximal end 218 and joined by a bridge member 220 at distal end 222. Preferably, bridge member 220 is sized to correspond with the native diameter of stent 210, allowing elongated members 214 and 216 to about the sides of stent 210, stabilizing it within cell 202. Also preferably, the diameters of elongated member 214 and 216 are sufficiently small to allow elongated member 214 and 216 to be threaded through or slid onto openings in stent 100. For example, a preferred diameter of elongated member 214 and 216 is in the range of approximately 39 mm to 40 mm.

Clip 210 can be formed from any material having sufficient strength at the desired diameter. Preferably, the material does not react with the stent material, the drug formulation or the solvent. A presently preferred material is stainless steel wire, but other metals including shape memory and superelastic alloys, polymers such as nylons, polyethylene and polyurethane, and composite materials can be used as desired. Also, elongated members 214 and 216 and bridge 220 of clip 210 are preferably monolithic to facilitate manufacture and for strength and reliability.

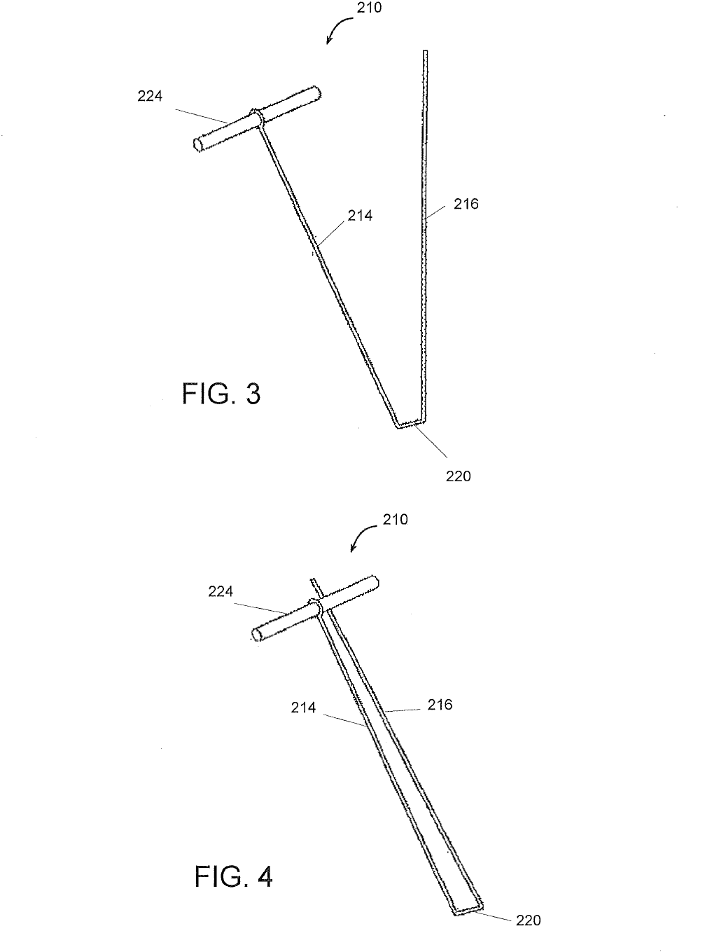

Further details regarding clip 210 are shown in FIGS. 3 and 4. In the embodiment shown, clip 210 is monolithically formed from a material having sufficient elasticity to allow it to assume the open configuration shown in FIG. 3 and the closed configuration shown in FIG. 4. In other embodiments, elongated members 214 and 216 can be secured to bridge member 220 using any suitable mechanism that features the requisite flexibility. Generally, the open configuration of clip 210 allows stent 100 to be loaded, with elongated members 214 and 216 either threaded through interstices in the framework of stent 100 or simply abutting the sides of stent 100. In some embodiments, bridge 220 can be configured to engage the distal end of stent 100 when properly positioned. A further implementation involves configuring bridge 220 to fit within openings of the framework structure of stent 100. When clip 210 is in its closed configuration, elongated members 214 and 216 preferably grip stent 100, frictionally engaging its sides to retain stent 100 in the desired orientation and position.

In currently preferred embodiments, the overall length of clip 210 corresponds to the respective interior dimension of cell 202, allowing it to fit closely within and constraining clip 210 to a narrow range of longitudinal positions within cell 202. Indeed, proximal 218 and distal 222 ends of clip 210 can engage the interior of cell 202 if desired. Stent 100 can therefore be retained within clip 210 at a position away from distal end 222, ensuring that the projecting ends of elongated members 214 and 216 hold stent 100 away from inlet 204.

Elongated member 214 can also comprise a handle 224 at proximal end 216. If desired, handle 224 can be configured to cooperate with one or more features of sample cell 202, such as a shoulder or receptacles, adjacent outlet 204 to hold clip 210 at a desired position within cell 202. As desired, the distal end of elongated member 216 can be configured to restrained by handle 224, holding clip 210 in its closed configuration. Holding clip 210 in a closed configuration containing the sample is then placed on the upper rim of cell 202. See attached additional diagrams and data supporting the claims.

In alternate embodiments, clip 210 can be configured so that stent 100 is placed coaxially over elongated member 214 and 216. Bridge 220 is sized to have a length slightly greater than the inner diameter of stent 100. Stent 100 is advanced to a distal position at which elongated members 214 and 216 engage the inner surface of the tubular stent 100, restraining stent 100 at the desired location and orientation.

As one of skill in the art will recognize, sample cell 202 can be used in a conventional manner for performing a dissolution analysis using a USP Apparatus 4. Specifically, clip 210 holds stent 100 at a specific position and orientation within cell 202 to ensure that laminar and similar flow conditions are experienced during each test and improve consistency. Further, clip 210 can be used to position stent 100 at a desired position, away from the turbulent, and thus variable, flow conditions adjacent inlet 204. By holding stent 100 away from the turbulence of inlet 204, the use of glass beads can be omitted in some implementations. In such embodiments, this avoids complications associated with variations in glass bead configuration, maintenance and the cleaning the beads between analyses. Alternatively, when desired, beads 208 can still be employed as discussed above to create a more laminar flow of solvent within cell 202.

Described herein are presently preferred embodiments. However, one skilled in the art that pertains to the present invention will understand that the principles of this disclosure can be extended easily with appropriate modifications to other applications.

What is claimed is:

1. A holder for a medical device undergoing dissolution analysis comprising a clip having first and second adjacent elongated members, each with proximal and distal ends, and a bridge joining the distal ends of the first and second elongated members, wherein the elongated members can be placed in an open configuration to receive a medical device and a closed configuration to retain the medical device.

2. The holder of claim 1, wherein the clip is configured to retain a stent.

3. The holder of claim 1, wherein the elongated members and bridge are formed from stainless steel.

4. The holder of claim 1, further comprising a handle secured to the proximal end of the first elongated member.

5. A system for holding a medical device undergoing dissolution analysis comprising a clip having first and second adjacent elongated members, each with proximal and distal ends, and a bridge joining the distal ends of the first and second elongated members, and a sample cell having an inlet and an outlet.

6. The system of claim 5, further comprising a medical device retained in a specific orientation by the elongated members of the clip.

7. The system of claim 6, wherein the medical device comprises a stent.

8. The system of claim 6, wherein the medical device is retained at a position away from the inlet of the sample cell.

9. The system of claim 6, wherein the clip is configured to be held at a specific position within the sample cell

10. A method for holding a medical device undergoing dissolution analysis comprising the steps of:
a) providing a clip having first and second adjacent elongated members, each with proximal and distal ends, and a bridge joining the distal ends of the first and second elongated members;
b) positioning a medical device at a reproducible orientation within the clip when the clip is in an open configuration;
c) retaining the medical device in the reproducible orientation by placing the clip in a closed configuration with the elongated members engaging the medical device; and
d) positioning the clip within a sample cell.

11. The method of claim 10, wherein the step of positioning a medical device comprises positioning a stent.

12. The method of claim 10, wherein the step of positioning the clip within a sample cell comprises positioning the medical device away from an inlet of the sample cell.

13. The method of claim 12, wherein the step of positioning the clip within a sample cell comprises constraining the clip to a specific location.
